(19) United States
(12) Patent Application Publication
(10) Pub. No.: US 2019/0177446 A1
(43) Pub. Date: Jun. 13, 2019

(54) PREACTIVATED CATALYST COMPONENT FOR THE POLYMERIZATION OF OLEFINS

(71) Applicant: BASELL POLYOLEFINE GMBH, Wesseling (DE)

(72) Inventor: MARTIN SCHNEIDER, HOCHHEIM (DE)

(73) Assignee: BASELL POLYOLEFINE GMBH, WESSELING (DE)

(21) Appl. No.: 16/076,149

(22) PCT Filed: Feb. 10, 2017
(86) PCT No.: PCT/EP2017/052953

§ 371 Date: Aug. 7, 2018

(30) Foreign Application Priority Data
Feb. 15, 2016 (EP) 16155626.1

(51) Int. Cl. C08F 4/659; C08F 4/655; B01J 31/14

(52) U.S. Cl. CPC C08F 4/65916; C08F 4/65912; C08F 110/02; B01J 31/143; C08F 4/6555

(57) ABSTRACT

A process for the preparation of pre-activated or pre-polymerized catalysts made from or containing a solid catalyst component made from or containing Ti, Mg, and halogen is disclosed. The resulting catalyst is protected from the release of flammable gases in contact with water. The process includes the steps of (a) a reaction step for yielding a catalyst precursor; (b) a reaction step in which the catalyst precursor is reacted with an organoaluminum compound for yielding a modified-catalyst precursor; (c) a treatment step in which the modified-catalyst precursor is treated with a mono or polychlorinated compound, thereby yielding the solid catalyst component; and (d) isolating and recovering the solid catalyst component.

### FIELD OF THE INVENTION

In general, the present disclosure relates to the field of chemistry. More specifically, the present disclosure relates to polymer chemistry. In particular, the present disclosure relates to a process for the manufacture of pre-activated or pre-polymerized catalysts for the polymerization of olefins.

### BACKGROUND OF THE INVENTION

Many processes for polyolefin manufacture are based on Ziegler and Ziegler-Natta catalysts.

For those processes, the catalysts can be obtained by reacting a transition metal compound with an organoaluminum compound.

In some instances, the transition metal compound is supported on a magnesium dihalide within solid catalyst components. In stereospecific polymerization of alpha olefins, an electron donor compound in the solid catalyst component (internal donor) can increase polymer stereoregularity. Moreover, if additional donors (external donors) are used in polymerization in combination with an Al-alkyl compound, the catalyst stereospecificity is further increased.

In some instances, prepolymerization of the catalyst with small quantities of olefinic monomers enhances the morphological stability of the catalyst and reduces the extent of fragmentation in the initial stages of polymerization. As a result, the regularity of polymer particle shape and the polymer bulk density may be increased.

In some instances, a catalyst precursor can be pre-activated by contacting the catalyst precursor with an aluminum alkyl compound in a Al/Ti ratio from higher than 0 to 10.

In some instances, the pre-polymerization and the preactivation of the catalyst leave active organometallic bonds on the resulting catalyst.

These bonds may be broken and release flammable gases upon contact with water. While this problem is relatively of minor impact in the polymerization process due to the presence of scavengers which eliminate the water presents in the reactants, it is of more concern when the catalyst have to be stored and/or shipped.

Generally speaking, the release of flammable gases is in contact with water is a transportation risk, because in case of a leakage of a catalyst container, flammable or combustible gas compositions can be formed in the presence of water or air humidity.

In addition to the total amount of gas released, it is also worth noting that the risk becomes higher with the increasing speed of gas development. The combination of these factors leads to certain UN transport classifications which, in some cases, provide for the necessity of transportation approvals by national authorities.

It is therefore felt the need of a process aimed at reducing or eliminating the tendency of the catalyst to produce flammable gases when in contact with water while, at the same time, not significantly changing the catalyst performances.

### SUMMARY OF THE INVENTION

In a general embodiment, the present disclosure provides a process for making a solid catalyst component including the steps of

(a) a reaction step carried out at a temperature ranging from about 0 to about 150° C. in which a Mg based compound of formula (MgClₘX₂₋ₘ).nLB, in which m ranges from 0 to 2, n ranges from 0 to 6, X is, independently R, OR, —OCOR or —OC(O)—OR group, in which R is a C₁-C₂₀ hydrocarbon group, and LB is a Lewis base, reacted with a Ti compound, and having at least a Ti—Cl bond, in an amount such that the Ti/Mg molar ratio is greater than about 0.1 optionally in the presence of an electron donor compound, thereby yielding a catalyst precursor;

(b) a reaction step in which the catalyst precursor of reaction step (a) is reacted with an organoaluminum compound in such an amount to have a Al/Ti ratio of about 0.01 to about 50 optionally in the presence of an amount of olefin monomer sufficient to yield from about 0.1 to about 50 grams of polymer per gram of catalyst precursor; optionally followed by at least one washing steps, thereby yielding a modified-catalyst precursor;

(c) a treatment step in which the modified-catalyst precursor of reaction step (b) is treated with a mono or polychlorinated R¹—Cl compound in a R¹Cl/Al ratio from about 0.01 to about 10 where R¹ is hydrogen or a C₁-C₂₀ hydrocarbon group, thereby yielding the solid catalyst component; and

(d) isolating and recovering the solid catalyst component. In a general embodiment, the present disclosure provides a solid catalyst component made by the process.

### DETAILED DESCRIPTION OF THE INVENTION

In some embodiments, the Mg based compound used as a starting compound in the reaction step (a) is a magnesium alcoholate of formula Mg(OR²)(OR³) compound, in which R² and R³ are identical or different and are each an alkyl radical having 1 to 10 carbon atoms. In some embodiments, R² and R³ are alkyl groups having from 2 to 10 carbon atoms or a radical —(CH₂)ₙOR⁴, where R⁴ is a C₁-C₄-alkyl radical and n is an integer from 2 to 6. In some embodiments, R² and R³ are C₁-C₂-alkyl radical. In some embodiments, the magnesium alkoxides are selected from the group consisting of magnesium dimethoxide, magnesium diethoxide, magnesium di-i-propoxide, magnesium di-n-propoxide, magnesium di-n-butoxide, magnesium methoxide ethoxide, magnesium ethoxide n-propoxide, magnesium di(2-methyl-1-pentoxide), magnesium di (2-methyl-1-hexoxide), magnesium di(2-methyl-1-heptoxide), magnesium di(2-ethyl-1-pentoxide), magnesium di(2-ethyl-1-hexoxide), magnesium di(2-ethyl-1-heptoxide), magnesium di(2-propyl-1-heptoxide), magnesium di(2-methoxy-1-ethoxide), magnesium di(3-methoxy-1-propoxide), magnesium di(4-methoxy-1-butoxide), magnesium di(6-methoxy-1-hexoxide), magnesium di(2-ethoxy-1-ethoxide), magnesium di(3-ethoxy-1-propoxide), magnesium di(4-ethoxy-1-butoxide), magnesium di(6-ethoxy-1-hexoxide), magnesium dipentoxide, and magnesium dihexoxide. In some embodiments, the magnesium alkoxides is selected from the group consisting of magnesium diethoxide, magnesium di-n-propoxide and magnesium di-isobutoxide. In some embodiments, the magnesium alkoxide is magnesium diethoxide.

In some embodiments, the magnesium alkoxide is used as a suspension or as a gel dispersion in a hydrocarbon medium. In some embodiments, the magnesium alkoxide is used as a gel dispersion. In some embodiments, the magnesium alkoxides have an average particle diameter ranging from about 200 to about 1200 μm, alternatively from about 500 to about 700 μm. In one embodiment, the particle size of the magnesium alkoxide is reduced before being used in the preparation of the catalyst. In that embodiment, the magnesium alcoholate is suspended in an inert, saturated hydrocarbon thereby creating a hydrocarbon suspension. In some embodiments, the suspension is subjected to high shear stress conditions by means of a high-speed disperser working under inert atmosphere. An example of high-speed disperser is Ultra-Turrax or Dispax, IKA-Maschinenbau Janke & Kunkel GmbH. In some embodiments, the inert atmosphere is argon or nitrogen. In some embodiments, the shear stress is applied until a gel-like dispersion is obtained. This dispersion is more viscous than the standard suspension. Compared with the suspended magnesium alcoholate, the dispersed magnesium alcoholate gel settles slower and to a lesser extent.

In some embodiments, the Ti compound is TiCl₄.

In one embodiment, the magnesium compound is a magnesium alkoxide and the reaction with TiCl₄ is carried out in an inert medium at a molar ratio of Ti/Mg ranging from about 0.1 to about 10, alternatively in the range about 0.2 to about 6. In some embodiments, the Ti/Mg molar ratio ranges from about 1.5 to about 4, alternatively in the range of about 1.75 to about 2.75. In some embodiments, the reaction temperature is range from about 50 to about 100° C., alternatively from about 60 to about 90° C. In some embodiments, the reaction time in the first stage is from about 0.5 to about 8 hours, alternatively from about 2 to about 6 hours.

In some embodiments, the inert suspension media for the reactions is selected from the group consisting of aliphatic hydrocarbons, cycloaliphatic hydrocarbons, and aromatic hydrocarbons. In some embodiments, the aliphatic hydrocarbons are selected from the group consisting of butane, pentane, hexane, heptane, and, isooctane. In some embodiments, the cycloaliphatic hydrocarbon is cyclohexane. In some embodiments, the aromatic hydrocarbons are selected from the group consisting of benzene and xylene. In some embodiments, petroleum spirit and hydrogenated diesel oil fractions, freed of oxygen, sulfur compounds and moisture, are used as the inert suspension media.

In some embodiments, the reaction step (a) is carried out in the presence of an electron donor compound. In some embodiments, the electron donor compound is selected from the group consisting of esters, ethers, amines, silanes and ketones. In some embodiments, the esters are selected from the group consisting of alkyl and aryl esters of mono or polycarboxylic acids. In some embodiments, the esters are selected from the group consisting of esters of benzoic, phthalic, malonic and succinic acid. In some embodiments, the esters are selected from the group consisting of n-butylphthalate, di-isobutylphthalate, di-n-octylphthalate, diethyl 2,2-diisopropylsuccinate, diethyl 2,2-dicyclohexyl-succinate, ethyl-benzoate and p-ethoxy ethyl-benzoate. In some embodiments, the ethers are selected from the group of 1,3 diethers of the formula:

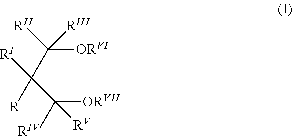

wherein R, R^{I}, R^{II}, R^{III}, R^{IV}, and R^{V} equal or different to each other, are hydrogen or hydrocarbon radicals having from 1 to 18 carbon atoms, and R^{VI} and R^{VII}, equal or different from each other, have the same meaning of R-R^{V} except that R ^{VI} and R^{VII} cannot be hydrogen; one or more of the R-R^{VII} groups can be linked to form a cycle. In some embodiments, the 1,3-diethers have R ^{VI} and R^{VII} selected from C₁-C₄ alkyl radicals. In some embodiments, the esters are diolesters donors disclosed in U.S. Pat. No. 7,388,061, incorporated herein by reference. In some embodiments, the donor mixture is selected from the group consisting of succinate esters and the 1,3-diether. In some embodiments, the 1,3-diethers are selected from diethers disclosed in Patent Cooperation Treaty Publication No. WO2012/139897, incorporated herein by reference.

In some embodiments, the electron donor compound is present in molar ratio with respect to the magnesium between about 1:4 and about 1:20.

In one embodiment, an electron donor is used in step (a) and the magnesium compound is selected from adducts of formula MgCl₂.nR⁵OH, where n is a number between about 0.1 and about 6, and R⁵ is a hydrocarbon radical having 1-18 carbon atoms. In some embodiments, n ranges from about 1 to about 5, alternatively from about 1.5 to about 4.5.

In some embodiments, the adduct is selected from the adducts disclosed in U.S. Pat. Nos. 4,399,054 and 4,469,648, both incorporated herein by reference. In some embodiments, the electron donor compound is used together with a MgCl₂.nR⁵OH adduct as Mg compound. In some embodiments, the Ti/Mg molar ratio higher than about 10. In some embodiments, the Ti compound is TiCl₄. In some embodiments, the reaction is carried out in an excess of liquid TiCl₄ at a temperature ranging from about 50 to about 150° C.

In some embodiments, the reaction step (a) is carried out one or more times under the same or different conditions.

In reaction step (b), the catalyst precursor of reaction step (a) is contacted with an organo-aluminum compound. In some embodiments, the amount of the organoaluminum compound is such that, calculated with reference to the Ti content of the catalyst precursor, to have a Al/Ti ratio of about 0.01 to about 25, alternatively from about 0.05 to about 10, alternatively from about 0.5 to about 10.

In some embodiments, the organo-aluminum compound is a trialkyl aluminum compound in which the alkyl is a C₁-C₁₆ carbon atoms or an alkyl aluminum chloride in which one or two alkyl groups have been replaced by chlorine groups.

In some embodiments, the tri-alkylaluminum compounds are selected from the group consisting of aluminum trimethyl, triethyl, triisobutyl and tri-n-octyl.

In some embodiments, the alkylaluminum chloride is selected from the group consisting of dialkylaluminum monochlorides of the formula R⁶₂AlCl and the alkylaluminum sesquichlorides of the formula R⁶₃Al₂Cl₃ in which R⁶ can be identical or different alkyl radicals having 1 to 16 carbon atoms. In some embodiments, the organoaluminum compound is selected from the group consisting of (C₂H₅)₂AlCl, (isobutyl)₂AlCl and (C₂H₅)₃Al₂Cl₃, (ethylaluminum sesquichloride). In some embodiments, the organoaluminum compound is (C₂H₅)₃Al₂C₃, (ethylaluminum sesquichloride). In some embodiments, the reaction is carried out in a stirred vessel at a temperature of from about 0° C. to about 150° C., alternatively from about 30° C. to about 100° C. for a time ranging from about 0.5 to about 5 hours.

In one embodiment, an aluminum alkylchloride compound is used in amounts such that the Al/Ti molar ratio, calculated with reference to the Ti content of the catalyst precursor, is from about 0.05 to about 1, alternatively from about 0.1 to about 0.5.

In some embodiments, reaction step (b) is carried out in the presence of small quantities of olefinic monomers, thereby producing a pre-polymerized catalyst.

In some embodiments, the amount of monomer used ranges from about 0.1 to about 100 grams of per gram of the catalyst precursor prepared in one or more reaction steps (a), alternatively from about 0.5 to about 50 grams. In some embodiments, the olefinic monomers are selected from the group consisting of ethylene, propylene, butene-1 and hexene-1.

In some embodiments, no monomer is present in reaction step (b) and an aluminum alkyl chloride is used.

In some embodiments, a monomer is present in reaction step (b) and a trialkyl aluminum compound is used.

In some embodiments, the catalyst precursor of reaction step (a) is first reacted with an aluminum alkyl chloride in the absence of a monomer, and then further reacted with a trialkyl aluminum compound in the presence of small amounts of olefinic monomers.

The modified-catalyst precursor of reaction step (b) is treated in the treatment step (c) with a mono or polychlorinated R¹—Cl compound in a R¹Cl/Al ratio from about 0.01 to about 10, alternatively from about 0.01 to about 5, alternatively from about 0.1 to about 3, alternatively from about 0.5 to about 3 where R¹ is hydrogen or a C₁-C₂₀ hydrocarbon group.

In some embodiments, the R¹—Cl compound is a chlorinated hydrocarbon selected from the group consisting of monochlorinated hydrocarbons. In some embodiments, the R¹—Cl compound is selected from the group consisting of monochlorinated alkyls having from 1 to 10 carbon atoms.

In some embodiments, the R¹—Cl compound is selected from the group consisting of hydrogen chloride, propylchloride, i-propylchloride, butylchloride, s-butylchloride, t-butylchloride 2-chlorobutane, cyclopentylchloride, cyclohexylchloride, 1,2-dichloroethane, and 1,6-dichlorohexane, In some embodiments, the R¹—Cl compound is selected from the group consisting of butyl chloride, i-propylchloride, 2-chlorobutane and cyclopentylchloride. In some embodiments, the component R¹—Cl is used in such amounts to give a molar ratio between with the Ti atoms contained in the modified-catalyst precursor of reaction step (b) of higher than about 2.5, alternatively higher than about 3, alternatively higher than about 3.5.

In some embodiments, reaction step (c) is carried out in the presence of a dispersion medium. In some embodiments, the dispersion medium is an inert liquid hydrocarbon.

In some embodiments, the solid catalyst coming from step (c) is then recovered and isolated from the slurry. In some embodiments, the recovery and isolation technique includes filtration and subsequent drying.

In some embodiments, the dried solid catalyst components are suspended in liquid hydrocarbons or more viscous substances. In some embodiments, the hydrocarbon is hexane. In some embodiments, the suspension liquid preserves the solid catalyst compounds from contact with water.

As explained above and illustrated in the working examples the so obtained catalysts when is put in contact with water releases no or very limited amount of flammable gases. This allows the catalyst to be packed and shipped with a low risk category. Moreover, it is worth noting that the reduction of flammable gas emission is obtained maintaining the catalyst performances in terms of activity and hydrogen response at substantially the same level so that catalyst users do not need to change operative parameters when using the catalyst.

In some embodiments, the solid catalyst component is used with an organo aluminum compound (B) in ethylene polymerization.

In some embodiments, the organoaluminum compound (B) is a trialkyl aluminum compound. In some embodiments, the trialkyl aluminum compound is selected from the group consisting of trimethylaluminum (TMA), triethylaluminum (TEAL), triisobutylaluminum (TIBA), tri-n-butylaluminum, tri n-hexylaluminum, tri-n-octylaluminum, and triisoprenylaluminum. In some embodiments, the trialkyl aluminum compound is selected from the group consisting of triethylaluminum (TEAL) and triisobutylaluminum (TIBA). In some embodiments, the organoaluminum compound (B) is an alkylaluminum halide. In some embodiments, the alkylaluminum halide is selected from the group consisting of alkylaluminum chlorides. In some embodiments, the alkylaluminum chloride is selected from the group consisting of diethylaluminum chloride (DEAC), diisobutylalumunum chloride, Al-sesquichloride and dimethylaluminum chloride (DMAC). In some embodiments, the organoaluminum compound (B) is a mixture an alkylaluminum halide with a trialuminum alkyl.

In some embodiments, the catalysts systems are used in a liquid phase polymerization process. In some embodiments, the solid catalyst components have an average particle size less than about 30 μm, alternatively ranging from about 7 to about 15 μm. In some embodiments, the catalyst systems are used in a slurry polymerization in an inert medium. In some embodiments, the slurry polymerization is carried out continuously in stirred tank reactors or in loop reactors. In some embodiments, the ethylene polymerization process is carried out in two or more cascade loop or stirred tank reactors producing polymers with different molecular weight and/or different composition in each reactor, thereby showing as a whole a broad molecular weight distribution.

In some embodiments, the catalysts are used for preparing very-low-density and ultra-low-density polyethylenes (VLDPE and ULDPE, having a density lower than about 0.920g/cm³ to about 0.880 g/cm³) consisting of copolymers of ethylene with one or more alpha-olefins having from 3 to 12 carbon atoms, having a mole content of units derived from ethylene of higher than about 80%. In some embodiments, the catalysts are used for preparing elastomeric copolymers of ethylene and propylene. In some embodiments, the catalysts are used for preparing elastomeric terpolymers of ethylene and propylene with smaller proportions of a diene having a content by weight of units derived from ethylene of between about 30 and about 70%, based upon the total weight of the elastomeric terpolymer.

### EXAMPLES

The results for the elemental composition of the catalysts described reported in the examples were obtained by the following analytical methods:
Ti: photometrically via the peroxide complex
Mg, Cl: titrimetrically
MFR_{5/190}: mass flow rate (melt index) in accordance with ISO1133, nominal load of 5 kg and test temperature=190° C.
FRR_{21.6/5}: flow rate ratio; quotient of MFR21.6g/190° and MFR5g/190°
Bulk density: in accordance with DIN EN ISO 60
d₅₀ (mean particle diameter): in accordance with DIN 53477 and DIN66144
M_{w}/Mₙ (polydispersity): Measure of the width of the molar mass distribution (M_{w}=weight average, Mₙ=number average), determined by the GPC method in accordance with DIN55672.
The measurements were carried out at 135° C. using trichlorobenzene as solvent.

### Reaction with Water Test

The test was performed at ambient temperature (20° C.) and atmospheric pressure in an inert gas atmosphere inside an apparatus consisting of a conical flask equipped with a dropping funnel and a syringe at a gas outlet junction at the upper part of the conical flask. Water (100 ml) was put into the dropping funnel, and the catalyst sample was placed in a conical flask. The tap of the dropping funnel was opened and allowed the water into the conical flask; a stop watch was started. The volume of gas evolved was measured by a syringe.

### Example 1

Preparation of the Solid Catalyst Component
The catalyst preparation steps were performed under inert gas atmosphere.
A catalyst component was prepared according to the procedure disclosed in example 2 of European Patent Application No. EP1507805, incorporated herein by reference. A dried catalyst sample was suspended in diesel oil (hydrogenated petroleum fraction having a boiling range from about 140 to about 170° C.). The stirred slurry was then treated with 1-butyl chloride in a ratio of 0.002 mol per g of solid catalyst at 75° C. for 2 hours. The 1-butyl chloride-treated catalyst sample was filtered and then dried by nitrogen purging.
The treated catalyst was subjected to the water test. Results are reported in Table 1.
Ethylene polymerization in suspension:
The polymerization experiments were carried out batchwise in a 1500 cm³ reactor. This reactor was equipped with an impeller stirrer. The temperature in the reactor was measured and automatically kept constant. The polymerization temperature was 85±1° C.
The polymerization reaction was carried out in the following way:
800 cm³ of diesel oil (hydrogenated petroleum fraction having a boiling range from about 140 to about 170° C.) were placed in a 1.5 dm³ reactor. The reactor was then heated to 85° C. Under a blanket of nitrogen, 2 mmol of triethylaluminum and the catalyst component in an amount corresponding to 0.05 mmol of titanium, as a suspension diluted with diesel oil, were introduced into the reactor. The reactor was then pressurized with 3.15 bar of hydrogen and 3.85 bar of ethylene. The total pressure of 7 bar was kept constant during the polymerization time of 2 hours by replacing the ethylene when consumed. The polymerization was stopped by shutting off the ethylene feed and venting the gases. The polymer powder was separated from the dispersion medium by filtration and drying.
The results of the polymerizations are shown in Table 1.

### Example 2 (Comparative)

The solid catalyst component of Example 1 was prepared, with the omission of the reaction step with the 1-butyl chloride, to make the comparative example.

The catalyst was subjected to the water reaction test as well as the ethylene polymerization procedure of Example 1. Results are shown in Table 1.

### Example 3

The solid catalyst component of Example 1 was prepared, using dry hydrogen chloride gas as a treatment agent purged through the catalyst slurry at a temperature of 50° C.

The catalyst was subjected to the water reaction test as well as the ethylene polymerization procedure of Example 1. Results are shown in Table 1.

TABLE 1

| | | Catalysts: | | |
|---|---|---|---|---|
| | | Exam- | | |
| | | ple 2 | | |
| | | (compar- | Exam- | Exam- |
| | | ative) | ple 1 | ple 3 |
| Catalyst pretreatment | | — | 1-Cl- | H—Cl |
| compound | | | Butane | |
| Catalyst pretreatment | [mol/g cat.] | — | 0.0020 | 0.0055 |
| amount | | | | |
| Polymerization test | | | | |
| PE amount | [g] | 87.4 | 86.3 | 90.7 |
| Activity | [g/mmol Ti] | 5.83 | 5.75 | 6.05 |
| MFI [190° C./5 kg] | [g/10 min] | 22.3 | 17.5 | 16.3 |
| Reaction with water test | | | | |
| Catalyst amount | [g] | 2.49 | 2.52 | 10.19 |
| gas developed in 1 min. | [l] | 0.068 | 0.009 | 0.058 |
| gas developed (total) | [l] | 0.085 | 0.017 | 0.060 |
| gas development speed | [l/min/kg] | 27 | 4 | 6 |
| in 1st min. | | | | |
| Category 1 minimum of | | yes | no | no |
| 10 l/min/kg exceeded | | | | |

What is claimed is:

1. A process for making a solid catalyst component comprising the steps of:
(a) a reaction step carried out at a temperature ranging from about 0 to about 150° C., in which a Mg based compound of formula (MgClₘX₂₋ₘ).nLB, in which m ranges from 0 to 2, n ranges from 0 to 6, X is, independently R, OR, —OCOR or —OC(O)—OR group, in which R is a C₁-C₂₀ hydrocarbon group, and LB is a Lewis base, reacted with a Ti compound, and having at least a Ti-Cl bond, in an amount such that the Ti/Mg molar ratio is greater than about 0.1 optionally in the presence of an electron donor compound thereby yielding a catalyst precursor;
(b) a reaction step in which the catalyst precursor of reaction step (a) is reacted with an organoaluminum compound in such an amount to have a Al/Ti ratio of about 0.01 to about 50, optionally in the presence of an amount of olefin monomer sufficient to yield from about 0.1 to about 50 grams of polymer per gram of catalyst precursor; optionally followed by at least one washing steps, thereby yielding a modified-catalyst precursor;
(c) a treatment step in which the modified-catalyst precursor of reaction step (b) is treated with a mono or polychlorinated R¹—Cl compound in a R¹Cl/Al ratio from about 0.01 to about 10 where R¹ is hydrogen or a C₁-C₂₀ hydrocarbon group, thereby yielding the solid catalyst component and
(d) isolating and recovering the solid catalyst component.

2. The process of claim 1 wherein the Mg compound is a magnesium alcoholate of formula Mg(OR²)(OR³) compound, in which R² and R³ are identical or different and are each an alkyl radical having 1 to 10 carbon atoms.

3. The process of claim 2 wherein R² and R³ are C₁-C₂-alkyl radical.

4. The process of claim 2 wherein the magnesium alcoholate is used as a gel dispersion.

5. The process of claim 1 wherein the Ti compound is TiCl₄.

6. The process of claim 2 wherein the molar ratio of Ti/Mg ranges from about 0.2 to about 6.

7. The process of claim 1 wherein, in reaction step (b), the catalyst precursor of the reaction step (a) is contacted with an organo aluminum compound in such an amount to have a Al/Ti ratio ranging from about 0.05 to about 10.

8. The process of claim 7 wherein the organoaluminum compound is a trialkyl aluminum compound in which the alkyl is a C₁-C₁₆ carbon atoms or an alkyl aluminum chloride in which one or two alkyl groups are replaced by chlorine groups.

9. The process of claim 8 wherein the organoaluminum compound is selected from the group consisting of aluminum trimethyl, triethyl, triisobutyl and tri-n-octyl, (C₂H₅)₂AlCl, (isobutyl)₂AlCl and (C₂H₅)₃Al2Cl₃.

10. The process of claim 1 wherein in the treatment step (c), the R¹—Cl compound is a monochlorinated hydrocarbon.

11. The process of claim 1 wherein the R¹—Cl compound is used in a R¹Cl/Al ratio from about 0.01 to about 5.

12. The process of claim 11 wherein the R¹—Cl compound is used in a R¹Cl/Al ratio from about 0.1 to about 3.

13. The process of claim 1 wherein the R¹—Cl compound is selected from the group consisting of hydrogen chloride, propylchloride, i-propylchloride, butylchloride, s-butylchloride, t-butylchloride, 2-chlorobutane, cyclopentylchloride, cyclohexylchloride, 1,2-dichloroethane, and 1,6-dichlorohexane.

14. The process of claim 1 wherein the reaction step (b) is carried out in the presence of small quantities of olefinic monomers₁ thereby producing a pre-polymerized catalyst.

15. The process of claim 14 wherein the amount of monomer ranges from about 0.1 to about 100 grams of per gram of the catalyst precursor prepared in reaction step (a).

16. A solid catalyst component prepared by a process comprising the steps of:
(a) a reaction step carried out at a temperature ranging from about 0 to about 150° C. , in which a Mg based compound of formula (MgClₘX₂₋ₘ).nLB, in which m ranges from 0 to 2, n ranges from 0 to 6, X is, independently R, OR, —OCOR or —OC(O)—OR group, in which R is a C₁-C₂₀ hydrocarbon group, and LB is a Lewis base, reacted with a Ti compound, and having at least a Ti-Cl bond, in an amount such that the Ti/Mg molar ratio is greater than about 0.1 optionally in the presence of an electron donor compound thereby yielding a catalyst precursor;
(b) a reaction step in which the catalyst precursor of reaction step (a) is reacted with an organoaluminum compound in such an amount to have a Al/Ti ratio of about 0.01 to about 50, optionally in the presence of an amount of olefin monomer sufficient to yield from about 0.1 to about 50 grams of polymer per gram of catalyst precursor;
optionally followed by at least one washing steps, thereby yielding a modified-catalyst precursor;
(c) a treatment step in which the modified-catalyst precursor of reaction step (b) is treated with a mono or polychlorinated R¹—Cl compound in a R¹Cl/Al ratio from about 0.01 to about 10 where R^{l} is hydrogen or a C₁-C₂₀ hydrocarbon group, thereby yielding the solid catalyst component; and
(d) isolating and recovering the solid catalyst component.
